(19) United States
(12) Patent Application Publication
(10) Pub. No.: US 2018/0016779 A1
(43) Pub. Date: Jan. 18, 2018

(54) ODOR ELIMINATOR FOR TOILET

(71) Applicant: Kenneth R. Courson, Valdosta, GA (US)

(72) Inventor: Kenneth R. Courson, Valdosta, GA (US)

(21) Appl. No.: 15/209,302

(22) Filed: Jul. 13, 2016

(51) Int. Cl. E03D 9/052; B01D 46/44; B01D 46/00; B01D 46/42

(52) U.S. Cl. CPC E03D 9/052; B01D 46/4272; B01D 46/44; B01D 46/0038; B01D 46/0041; B01D 2279/00

(57) ABSTRACT

A filtration system for eliminating odor, includes a suction pipe, a connecting pipe, an adaptor, a fan and a filter box. The suction pipe is opened with a first end and an opposite, second end. The connecting pipe is connected to the second end. The adapter is connected to the connecting pipe. The fan is connected to the adapter. The filter box accommodates the fan and a filter material. The suction pipe is fixed to a top surface at a back side of a toilet bowl, the first end of the suction pipe faces the toilet bowl, and the adapter and the fan are fixed to the filter box. When at work, the fan generates a suction force such that air around the toilet bowl moves through the suction pipe, the connecting pipe, and the adapter into the filter box, and is processed by the filter material.

### FIELD OF THE INVENTION

The invention relates generally to an odor elimination system for a toilet, and more particularly to an odor elimination system using vacuum fan and odor eliminating filter, and applications of the same.

### BACKGROUND OF THE INVENTION

The background description provided herein is for the purpose of generally presenting the context of the present invention. The subject matter discussed in the background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions. Work of the presently named inventors, to the extent it is described in the background of the invention section, as well as aspects of the description that may not otherwise qualify as prior art at the time of filing, are neither expressly nor impliedly admitted as prior art against the present invention.

The use of private or public restrooms often results in an odor that, at best, is annoying and embarrassing and, at worst, renders the facilities unusable. The use of standard exhaust fans do not work well and sometimes make things worse by filling the restroom with the foul odor before it can be removed. Many people may flush the toilet two and three times in an effort to remove or minimize the odor. This is simply ineffective and also generates unnecessary waste water.

Therefore, a heretofore unaddressed need exists in the art to address the aforementioned deficiencies and inadequacies.

### SUMMARY OF THE INVENTION

In one aspect, the present invention relates to a filtration system for eliminating odor. In certain embodiments, the filtration system includes a suction pipe, a connecting pipe, an adapter, a fan and a filter box. The suction pipe is opened with a first end and an opposite, second end. The connecting pipe is connected to the second end of the suction pipe. The adapter is connected to the connecting pipe. The fan is connected to the adapter. The filter box accommodates the fan and a filter material. The suction pipe is fixed to a top surface at a back side of a toilet bowl, the first end of the suction pipe faces the toilet bowl, and the adapter and the fan are fixed to the filter box. When at work, the fan generates a suction force such that air around the toilet bowl moves through the suction pipe, the connecting pipe, and the adapter into the filter box, and is processed by the filter material in the filter box.

In certain embodiments, the filtration system further includes a pressure sensor disposed on the upper surface of the toilet bowl. When a seat of the toilet is pulled down during use and thereafter occupied, the seat presses the pressure sensor, and the pressure sensor sends a signal to the fan to turn on the fan.

In certain embodiments, the second end of the suction pipe has a circular shape, the first end of the suction pipe has a flattened shape, an opening at the first end of the suction pipe is smaller than an opening at the second end of the suction pipe, so as to increase a suction force at the first end of the suction pipe. The suction pipe includes a first pipe portion having the first end, and a second pipe portion having the second end, and the first pipe portion is bent from the second pipe portion.

In certain embodiments, the connecting pipe has a first end connecting with the second end of the suction pipe, and a second end connecting with the adapter; the adapter has a first end connecting with the second end of the connecting pipe, and a second end connecting with the fan; and the adaptor further includes a flange at the second end of the adaptor, so as to fix and seal the adaptor to the filter box.

In certain embodiments, the filtration system further includes a check valve such that the air around the toilet bowl only moves in a direction from the suction pipe toward the connecting pipe.

In certain embodiments, the filter box is fixed to a floor. The filter box further has at least one open hole, and at least part of the filter material is disposed between the fan and the open hole. In certain embodiments, the open hole is covered by a transparent screen, and a height of the filter material is at least 1 inch greater than a top of the open hole. In certain embodiments, the filter box further has a lid or a door, such that the filter material in the filter box is changeable through the lid or the door.

In certain embodiments, the suction pipe, the connecting pipe, and the adaptor are made of a polyvinyl chloride (PVC) material.

In certain embodiments, the filtration system is built into the toilet bowl.

In another aspect, the present invention relates to a filtration system for eliminating odor. In certain embodiments, the filtration system includes a suction pipe, a connecting pipe, a first adaptor, a fan, and a second adaptor. The suction pipe is opened with a first end and an opposite, second end. The connecting pipe is connected to the second end of the suction pipe. The first adapter is connected to the connecting pipe. The fan is connected between the first adapter and the second adapter. The second adapter is connected with a vent pipe. The suction pipe is fixed to a top surface at a back side of a toilet bowl, the first end of the suction pipe faces the toilet bowl. When at work, the fan generates a suction force such that air around the toilet bowl moves through the suction pipe, the connecting pipe, the first adapter, the fan, and the second adaptor into the vent pipe.

In certain embodiments, the filtration system further includes a pressure sensor disposed on the upper surface of the toilet bowl. When a seat of the toilet is pulled down during use and thereafter occupied, the seat presses the pressure sensor, and the pressure sensor sends a signal to the fan to turn on the fan.

In certain embodiments, the filtration system further includes a check valve disposed in the vent pipe and adjacent to the second adaptor, to prevent backflow of the air toward the second adaptor.

In certain embodiments, the filtration system further includes a filter between the fan and the second adaptor to remove odor from the air.

In certain embodiments, the second end of the suction pipe has a circular shape, the first end of the suction pipe has a flattened shape, an opening at the first end of the suction pipe is smaller than an opening at the second end of the suction pipe, so as to increase a suction force at the first end of the suction pipe. In certain embodiments, the suction pipe includes a first pipe portion having the first end, and a second pipe portion having the second end, and the first pipe portion is bent from the second pipe portion.

In a further aspect, the present invention relates to a toilet having a filtration system for eliminating odor. The filtration system includes a suction pipe, a fan, and a connecting pipe. The suction pipe has an opening in a bowl of the toilet. The fan is connected to the suction pipe. The connecting pipe has a first end connected with the fan, and a second connected with a drain. When at work, the fan generates a suction force such that air around the toilet bowl moves through the suction pipe, the fan, and the connecting pipe to the drain.

In certain embodiments, the suction pipe, the fan, and part of the connecting pipe are integrally formed in the toilet, and the connecting pipe is connected to the drain after a P-trap of the drain.

These and other aspects of the present invention will become apparent from the following description of the embodiment taken in conjunction with the following drawings, although variations and modifications therein may be affected without departing from the spirit and scope of the novel concepts of the present invention.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment.

FIG. 1 schematically shows a side view of a filtration system according to one embodiment of the invention.

FIG. 2 schematically shows a top view of the filtration system of FIG. 1.

FIG. 3A schematically shows a side view of a suction pipe of a filtration system according to one embodiment of the invention.

FIG. 3B schematically shows a front view of the suction pipe of FIG. 3A.

FIG. 3C schematically shows a top view of the suction pipe of FIG. 3A.

FIG. 4A schematically shows a side view of a connecting pipe of a filtration system according to one embodiment of the invention.

FIG. 4B schematically shows a top view of the connecting pipe of FIG. 4A.

FIG. 5A schematically shows a side view of an adaptor of a filtration system according to one embodiment of the invention.

FIG. 5B schematically shows a top view of the adaptor of FIG. 5A.

FIG. 6A schematically shows a side view of a filter box of a filtration system according to one embodiment of the invention.

FIG. 6B schematically shows a top view of the filter box of FIG. 6A.

FIG. 7 schematically shows a side view of a filtration system according to one embodiment of the invention.

FIG. 8 schematically shows a top view of the filtration system of FIG. 7.

### DETAILED DESCRIPTION OF THE INVENTION

The invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. It will be appreciated that the same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only and in no way limits the scope and meaning of the invention or of any exemplified term. Likewise, the invention is not limited to various embodiments given in this specification.

As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below can be termed a second element, component, region, layer or section without departing from the teachings of the present invention.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” to another feature may have portions that overlap or underlie the adjacent feature.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, or “includes” and/or “including” or “has” and/or “having” when used in this specification specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top”, may be used herein to describe one element's relationship to another element as illustrated in the FIGS. It will be understood that relative terms are intended to encompass different orientations of the device in addition to the orientation shown in the FIGS. For example, if the device in one of the figures is turned over, elements described as being on the “lower” side of other elements would then be oriented on the “upper” sides of the other elements. The exemplary term “lower” can, therefore, encompass both an orientation of lower and upper, depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present invention, and will not be interpreted in an idealized or overly formal sense unless expressly so defined herein.

As used herein, “around”, “about”, “substantially” or “approximately” shall generally mean within 20 percent, preferably within 10 percent, and more preferably within 5 percent of a given value or range. Numerical quantities given herein are approximate, meaning that the terms “around”, “about”, “substantially” or “approximately” can be inferred if not expressly stated.

As used herein, the terms “comprise” or “comprising”, “include” or “including”, “carry” or “carrying”, “has/have” or “having”, “contain” or “containing”, “involve” or “involving” and the like are to be understood to be open-ended, i.e., to mean including but not limited to.

As used herein, the phrase “at least one of A, B, and C” should be construed to mean a logical (A or B or C), using a non-exclusive logical OR. It should be understood that one or more steps within a method may be executed in different order (or concurrently) without altering the principles of the invention.

The description will be made as to the embodiments of the invention in conjunction with the accompanying drawings. In accordance with the purposes of this invention, as embodied and broadly described herein, this invention, in one aspect, relates to a filtration system and applications of the same.

Certain embodiments of the present invention provides a filter system to eliminate odor in a restroom at the source, that is, remove the odor from the toilet bowl before it invades the restroom. The filter system may include a small vacuum on the toilet bowl and venting the odor outside before it fills the room. The filter system may be used in both private and public restroom. The filter system according to certain embodiments can be installed to the current available toilet to add the function of removing odor, or may be built into a brand new toilet as an integral part of the toilet. In certain embodiments, a filter box is provided to absorb the odor, so that extra venting to outside is not required.

In a certain embodiment, the present invention utilizes a suction pipe that will fit under the seat opening piped out to a suction fan and into the filter box with odor eliminating granules then back into the room with no odor.

In a certain embodiment, the present invention is much the same as above, with the suction pipe built into the seat hinge and the fan and filter built into the lid, thus requiring no separate box containing these elements on the floor.

In a certain embodiment, the present invention does not need a filter as the air from the bowl is vented into the vent stack pipe. This embodiment requires a check valve to keep any backflow from the vent pipe entering the room.

In a certain embodiment, the present invention is primarily designed for new installation with the suction pipe fan and check valve built into the toilet casting and vented into the drain after the P-trap in the toilet. It also uses a small fan and check valve to eliminate any back flow from the sewer line.

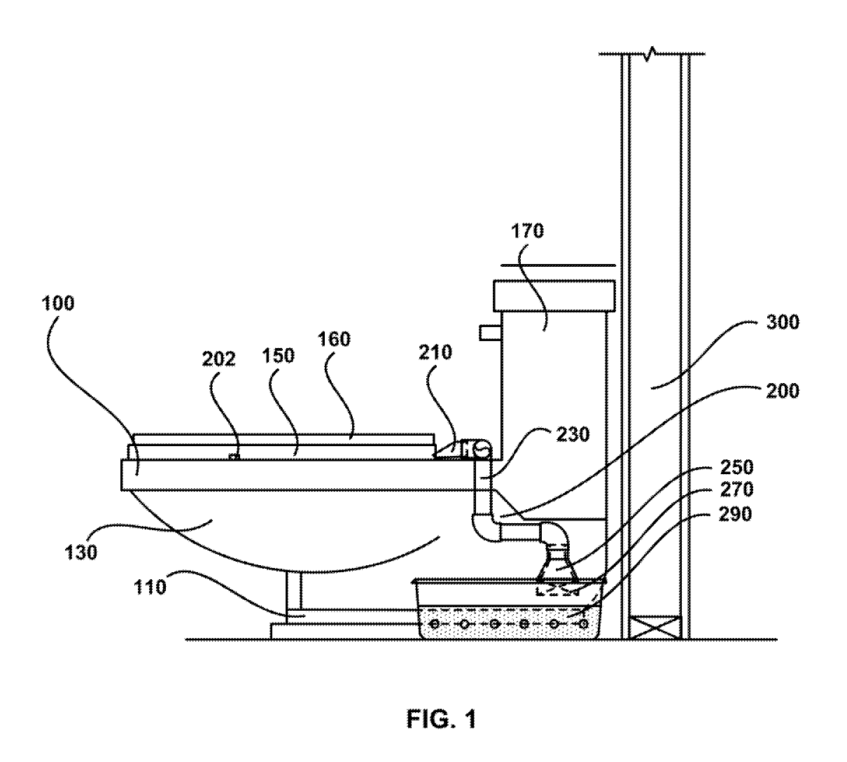

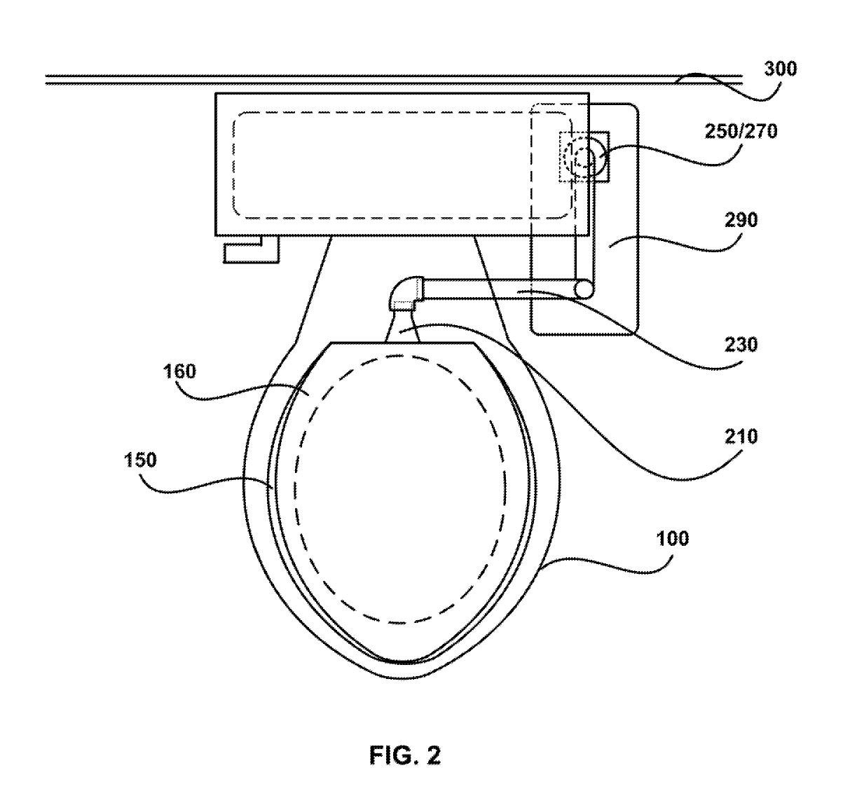

FIG. 1 schematically shows a side view of a filtration system according to one embodiment of the invention, FIG. 2 schematically shows a top view of the filtration system. The filtration system can be used in restroom to remove odor during use of the restroom. As shown in FIGS. 1 and 2, the restroom 10 has a toilet bowl 100, a filtration system 200, and a wall 300 that may have a vent pipe. The toilet bowl 100 includes a base 110, a bowl body 130, a seat 150 and a lid 160 hinged to the bowl body 130, and a water storage tank 170 located behind the bowl 130. The filtrations system 200 includes a suction pipe 210, a connecting pipe 230, an adaptor 250, a fan 270 and a filter box 290 connected sequentially.

The filtrations system may further have a pressure sensor 202 to detect whether the seat 150 is in an open position or a close position (work position). When the seat 150 is in the open position adjacent to the water storage tank 170, the pressure sensor 202 is in an off status. When a user pulls down the seat 150 and occupies the seat 150, such that the seat 150 lies on the top surface of the bowl 130, the seat 150 pushes the pressure sensor 202, the pressure sensor 202 is in an on status. The pressure sensor 202 then sends a signal to the fan 270 to turn on the fan. In certain embodiments, the pressure sensor 202 is electrically connected with the fan 270. In other embodiments, the pressure sensor 202 may not be directly connected with the fan 270, as long as the pressure sensor 202 is able to send a signal to the fan 270 to turn on the fan. For example, the pressure sensor 202 may be in communication with the fan 270 wirelessly or in any other suitable ways. In this embodiment, the pressure sensor 202 is located on the top surface of the bowl body 130 so that it can conveniently detect the status of the seat 150. The pressure sensor 202 may located at any part of the toilet bowl as long as it can be pressed by the seat 150 when the seat 150 is in a work status, for example, the pressure sensor 202 may be disposed at the lower side of the seat 150. In other embodiments, the pressure sensor 202 may also located at other places and the user may turn on the pressure sensor manually. In this case, the pressure sensor 202 may be an on/off switch located on the fan or in communication with the fan. In certain embodiments, the on/off switch 202 of the fan may also be in communication with a light switch of the restroom. The sensor may also be another type of sensor other than the pressure sensor, as long as the sensor can be used to detect the use of the toilet or capable of actuation for turn on/off by the user. In certain embodiments, the sensor is in electrical communication with the fan 270.

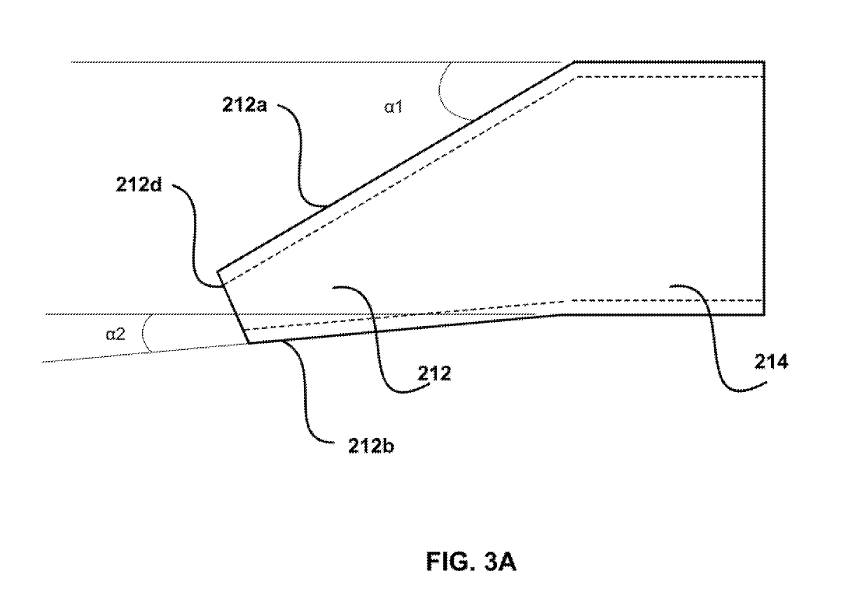

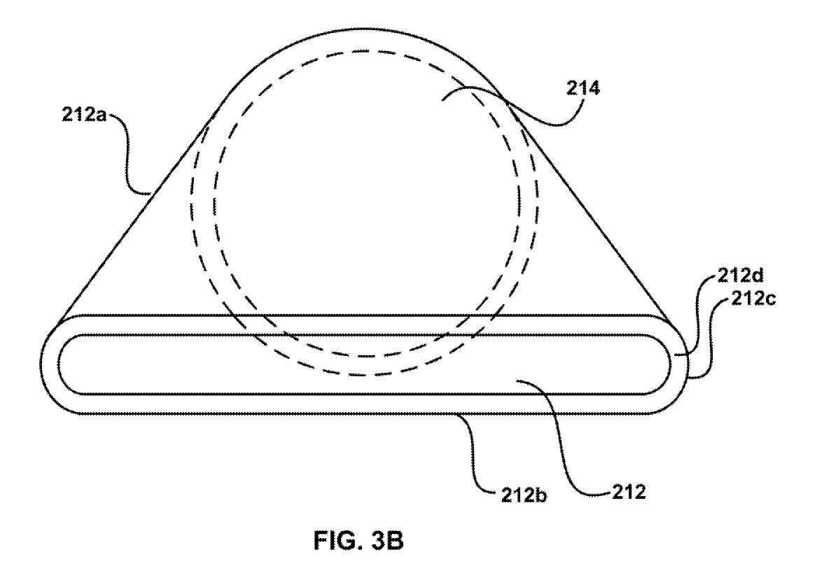

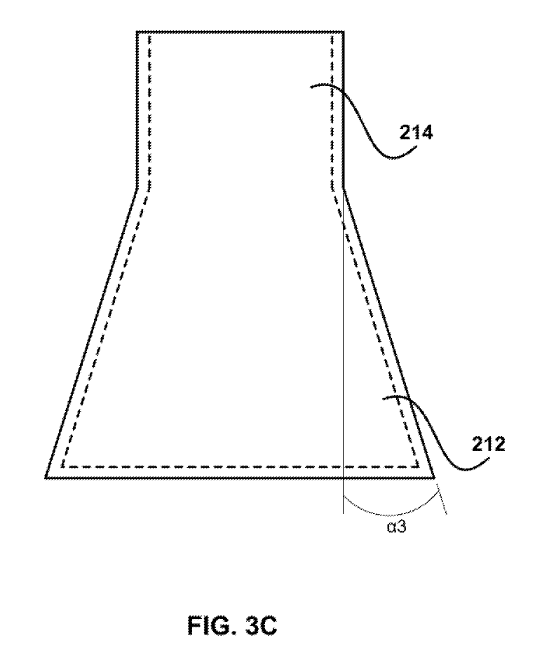

As shown in FIGS. 1 and 2, the suction pipe 210 is disposed behind the seat 150, and may be fixed at the hinge position of the seat 150. FIG. 3A schematically shows a side view of a suction pipe of a filtration system according to one embodiment of the invention. FIG. 3B schematically shows a front view of the suction pipe of FIG. 3A. FIG. 3C schematically shows a top view of the suction pipe of FIG. 3A. In certain embodiments, the total length of the suction pipe 210 is in a range of 2-15 cm. In certain embodiments, the total length of the suction pipe 210 is in a range of 4-9 cm. In one embodiment, the total length of the suction pipe 210 is about 5.84 cm (2.30 inch). In certain embodiments, the suction pipe 210 is made from ¾ inch schedule 20 PVC pipe.

As shown in FIGS. 3A-3C, the suction pipe 210 includes a front portion 212 and a back portion 214. The front portion 212 extends forward from the back portion 214 and bends from the back portion 214. In certain embodiments, the front portion 212 is bent and flattened from a regular tube. The front portion 212 has a top surface 212a, a bottom surface 212b, two side surfaces 212c, and a front surface 212d. In certain embodiments, the projected length of the front surface 212a is in a range of 1-15 cm. In certain embodiments, the projected length of the front surface 212a is in a range of 2.5-5 cm. In one embodiment, the projected length of the front surface 212a is about 3.8 cm (1.5 inch). As shown in FIG. 3B, the front surface 212d has an opening formed with a top straight line, a bottom straight line, and two side lines connecting the top and bottom straight lines. The length of the front surface 212d, when viewing from the front as shown in FIG. 3B, and calculated from the peak of the arc of the two side lines, is in a range of 1.5-20 cm. In certain embodiments, the length of the front surface 212d is in a range of 3.5-7 cm. In one embodiment, the length of the front surface 212d is about 5.1 cm (2 inch). The projected height of the front surface 212d, when viewing from the front as shown in FIG. 3B, and calculated vertically between the top surface and the bottom surface of the opening, is in a range of 0.15-4 cm. In certain embodiments, the height of the front surface 212d is in a range of 0.5-1 cm. In one embodiment, the height of the front surface 212d is about 0.76 cm (0.3 inch). As shown in FIG. 3A, the top surface 212a bends from the top of the back portion 214, and forms an angle α1 with the top of the back portion 214. The bottom surface 212b bends from the bottom of the back portion 214, and forms an angle α2 with the bottom of the back portion 214. In certain embodiment, the angle α1 is in a range of 15−45°. In certain embodiment, the angle α1 is in a range of 25−35°. In one embodiment, the angle α1 is about 30.40°. In certain embodiment, the angle α2 is in a range of 1−20°. In certain embodiment, the angle α2 is in a range of 3−10°. In one embodiment, the angle α2 is about 5°. As shown in FIG. 3C, when viewing from the top, the side surface 212c of the front portion 212 forms an angle α3 with the side of the back portion 214. In certain embodiment, the angle α3 is in a range of 5−35°. In certain embodiment, the angle α3 is in a range of 10-25°. In one embodiment, the angle α3 is about 17.40°. In certain embodiments, the presence of the angles α1 and α3 makes the front opening of the suction pipe to have a smaller area than the opening at the rear end, which increases the suction force of the suction pipe 210. Further, the presence of the angle α2 makes the front portion of the suction pipe 210 bend downward a little bit from the horizontal direction. That is, the front opening of the suction pipe 210 faces more toward the inside of the cavity of the bowl, and avoids possible blockage from the rear end of the seat 150, which makes the suction of the odor more efficient.

In certain embodiments, the back portion 214 has a regular tube shape. The tube of the back portion 214 has a diameter in the vertical direction, has a length in the longitudinal direction, and has a thickness from the outer surface of the tube through the inner surface of the tube. In certain embodiments, the diameter (outer diameter) of the tube of the back portion 214 is in a range of 0.6-12 cm. In one embodiment, the diameter of the back portion 214 is in a range of 2.0-3.5 cm. In one embodiment, the diameter of the back portion 214 is about 2.69 cm (1.06 inch). In certain embodiments, the length of the back portion 214 is in a range of 0.4-8 cm. In one embodiment, the length of the back portion 214 is in a range of 12-3 cm. In one embodiment, the length of the back portion 214 is about 2.03 cm (0.80 inch). In certain embodiments, the thickness of the back portion 214 is in a range of 0.05 cm-1.5 cm. In one embodiment, the thickness of the back portion 214 is in a range of 0.2 cm-0.45 cm. In one embodiment, the thickness of the back portion 214 is about 0.30 cm (0.12 inch). In certain embodiments, the thickness of the front portion 212 is substantially the same as the thickness of the back portion 214. In certain embodiments, the thickness of the front portion 212 is about 1-30% less than the thickness of the back portion 214. In certain embodiments, the thickness of the front portion 212 is about 2-20% less than the thickness of the back portion 214. In certain embodiments, the thickness of the front portion 212 is about 5-10% less than the thickness of the back portion 214.

As described above, in one example, the suction pipe 210 is made from ¾ inch schedule 20 PVC pipe. The front portion 212 is formed by heating, bending and flattening from the PVC pipe. The flattening of the PVC pipe forms the flat opening of the front portion 212, which increases suction force of the suction pipe 210, and removes odor efficiently. In other examples, the suction pipe 210 may be integrally formed by injection molding to form the designed shape. In a further example, the suction pipe 210 may be built in a toilet bowl during the manufacturing of the toilet bowl. The suction pipe 210 may be formed from plastic, ceramic, metal or any other suitable material. In certain embodiments, the suction pipe 210 may be produced by forming a cavity in the toilet bowl during the manufacturing of the toilet bowl, such that no any other material is needed for forming the suction pipe 210.

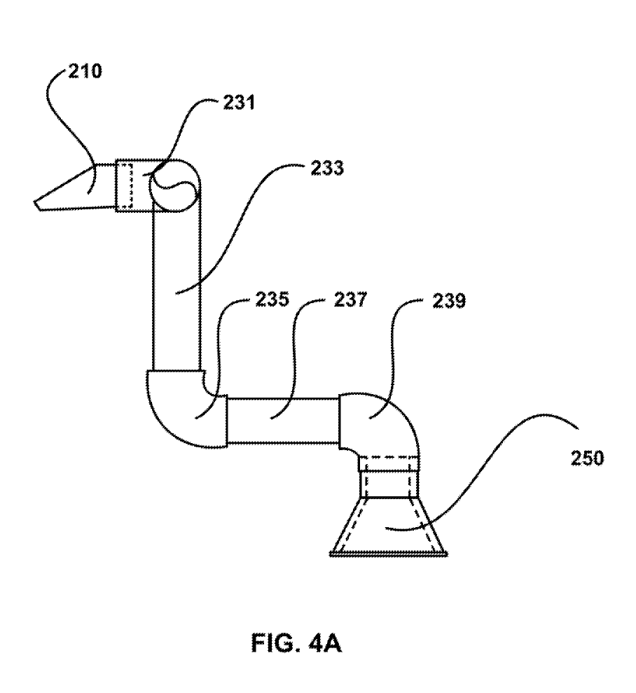

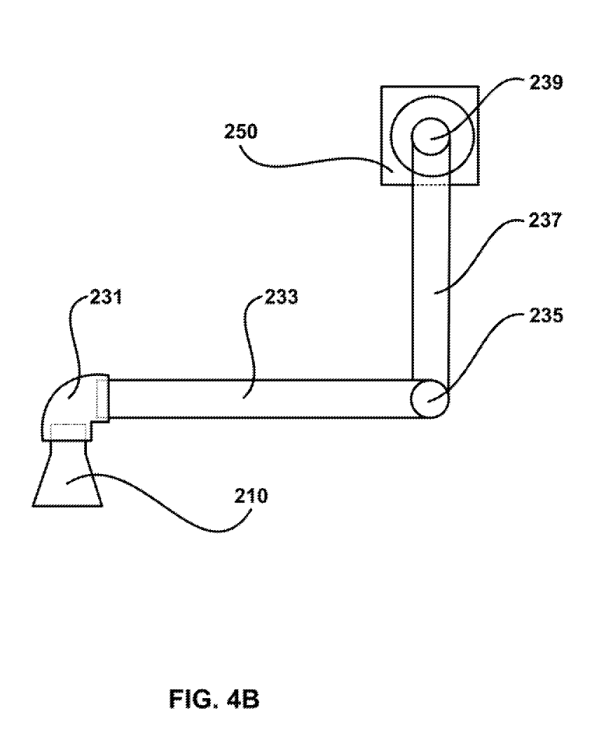

FIG. 4A schematically shows a side view of a connecting pipe of a filtration system according to one embodiment of the invention. FIG. 4B schematically shows a top view of the connecting pipe of FIG. 4A. In certain embodiments, as shown in FIGS. 4A and 4B, the connecting pipe 230 includes a first connector 231, a vertical portion 233, a second connector 235, a horizontal portion 237, and a third connector 239. The vertical portion 233 is substantially perpendicular to the floor, and the horizontal portion 237 is substantially parallel to the floor. The first connector 231 connects the suction pipe 210 with the vertical portion 233, the second connector 235 connects the vertical portion 233 with the horizontal portion 237, and the third connector 239 connects the horizontal portion 237 with the adaptor 250. The embodiment of the connecting pipe 230 shown in FIGS. 4A and 4B is only for exemplary purpose and not used to limit the scope of the present invention. Any other forms of the connecting pipe 230 that is able to connecting the suction pipe 210 and the adapter 250, fit with the available structure of the restroom and the toilet bowl, and does not block the user from conveniently using the toilet, is within the scope of this invention. In certain embodiments, the vertical portion 233 and the horizontal portion 237 are made of ¾ inch schedule 20 PVC pipe, and the first, second and third connectors 231, 235 and 239 are connectors that fit with the ¾ inch schedule 20 PVC pipe.

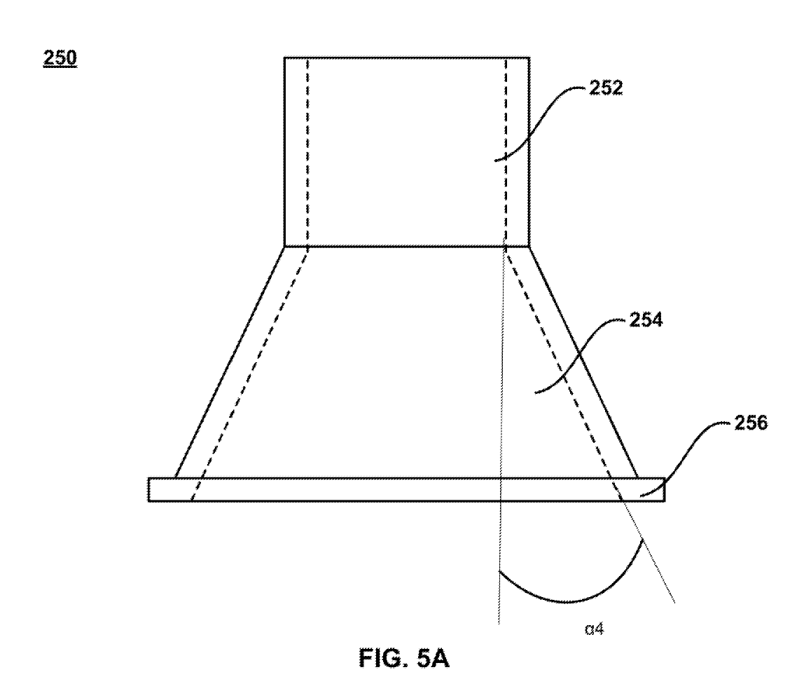

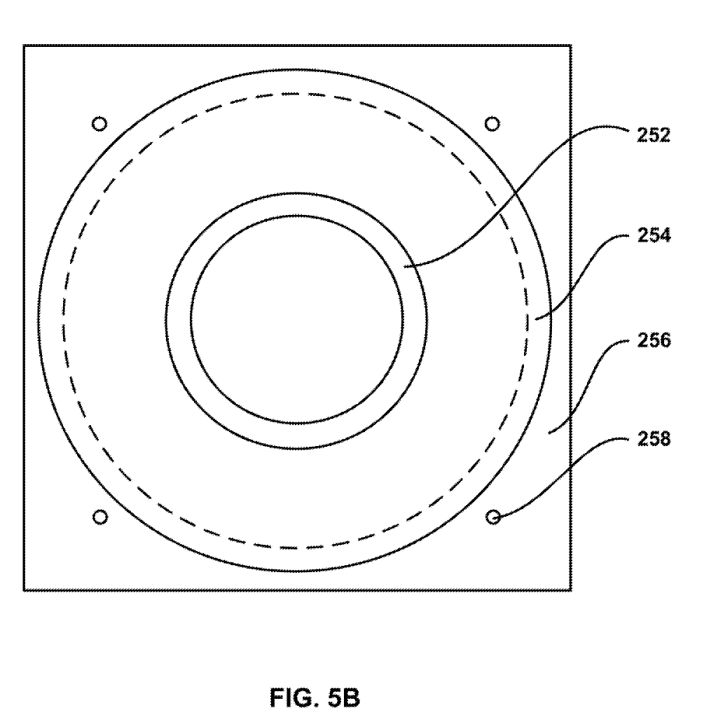

FIG. 5A schematically shows a side view of an adaptor of a filtration system according to one embodiment of the invention. FIG. 5B schematically shows a top view of the adaptor of FIG. 5A. As shown in FIGS. 5A and 5B, the adaptor 250 includes a first portion 252 at the top, a second portion 254 below the first portion 252, and a flange 256 surrounding the bottom circumference of the second portion 254. In certain embodiments, the first portion 252, the second portion 254 and the flange 256 may be formed separately and then assembled together by variety of methods such as heating and/or welding and/or bonding/gluing. In other embodiments, at least two of the first portion 252, the second portion 254 and the flange 256 may be integrally formed by methods such as inject molding.

The first portion 252 is in a shape of a circular pipe. The diameter of the first portion 252 is slightly smaller than the diameter of the third connector 239 so that the first portion 252 is insertable and fixable to the third connector 239. In certain embodiments, the outer diameter of the first portion 252 of the adaptor 250 is in a range of 0.8-12 cm. In one embodiment, the outer diameter of the first portion 252 is in a range of 2.5-4.5 cm. In one embodiment, the outer diameter of the first portion 252 is about 3.3 cm (1.30 inch). In certain embodiments, the inner diameter of the first portion 252 of the adaptor 250 is in a range of 0.6-12 cm. In one embodiment, the inner diameter of the first portion 252 is in a range of 2.0-3.5 cm. In one embodiment, the inner diameter of the first portion 252 is about 2.69 cm (1.06 inch). In certain embodiments, the thickness of the first portion 252 of the adaptor 250 is in a range of 0.05 cm-1.5 cm. In one embodiment, the thickness of the first portion 252 is in a range of 0.2-0.45 cm. In one embodiment, the thickness of the first portion 252 is about 0.30 cm (0.12 inch). In certain embodiments, the height of the first portion 252 in the vertical direction is in a range of 0.5-10 cm. In one embodiment, the thickness of the first portion 252 is in a range of 1.5 cm-3.5 cm. In one embodiment, the thickness of the first portion 252 is about 2.54 cm (1 inch).

The second portion 254 is connected with the first portion 252. As shown in FIG. 5A, the top of the second portion 254 is basically has the same circular size and thickness as the first portion 252, and is connected with the first portion 252. The thickness of the second portion 254 is substantially the same from the top of the second portion 254 to the bottom of the second portion 254. The second portion 254 is enlarged from top to bottom continuously. The bottom opening of the second portion 254 has an inner diameter. In certain embodiments, the inner diameter of the second portion 254 of the adaptor 250 is in a range of 2 cm-25 cm. In one embodiment, the inner diameter of the second portion 254 is in a range of 4 cm-8 cm. In one embodiment, the inner diameter of the second portion 254 is about 5.84 cm (2.30 inch). The side of the second portion 254 forms an angle α4 with the vertical direction. In certain embodiment, the angle α4 is in a range of 10−40°. In certain embodiment, the angle α4 is in a range of 20−30°. In one embodiment, the angle α4 is about 25°.

The flange 256 surrounds the circumference of the bottom of the second portion 254. In certain embodiments, the flange 256 has a shape of a square. The length of the side of the square of the flange 256 is in a range of 2-30 cm. In certain embodiments, the length of the side of the flange 256 is in a range of 4.5-9 cm. In one embodiment, the length of the side of the flange 256 is about 7 cm (2.75 inch). When viewing from the side as shown in FIG. 5A, the thickness of the flange 256 is in a range of 0.05-1.5 cm. In certain embodiments, the thickness of the flange 256 is in a range of 0.2-0.45 cm. In one embodiment, the thickness of the flange 256 is about 0.3 cm (0.12 inch). In certain embodiments, fixing holes 258, which are through holes, are provided on the flange 256, so as to fix the flange 256 to at least one of the filter box 290 and the fan 270. As shown in FIG. 5B, the number of the fixing holes 258 may be four, and the four through holes 258 are located symmetrically on the flange 256. In certain embodiments, the four through holes are located at two diagonal lines of the flange 256 and forms a square shape symmetrically. The length of the side of the square formed by the fixing holes 258 is in a range of 1.5-20 cm. In certain embodiments, the length of the side of the square formed by the fixing holes 258 is in a range of 3.5-7 cm. In one embodiment, the length of the side of the square formed by the fixing holes 258 is about 5.1 cm (2 inch). This length is the distance between two adjacent fixing holes 258.

The fan 270 is fixed with the adaptor 250. The fan 270 may be any small vacuum fan that is able move air in a pre-determined direction, so as to form a local vacuum. The filter system is substantially a sealed system, with an opening at the front of the suction pipe 210 and possible outlet at the filter box 290. When the fan 270 is turned on, air is moved from the suction pipe 210, through the connecting pipe 230 and the adaptor 250, and enter the filter box 290. The odor in the air is then absorbed by the filter material accommodated in the filter box 290. In certain embodiments, the fan 270 may be located at any position of the filter system, as long as it is between the suction pipe 210 and the filter material 400.

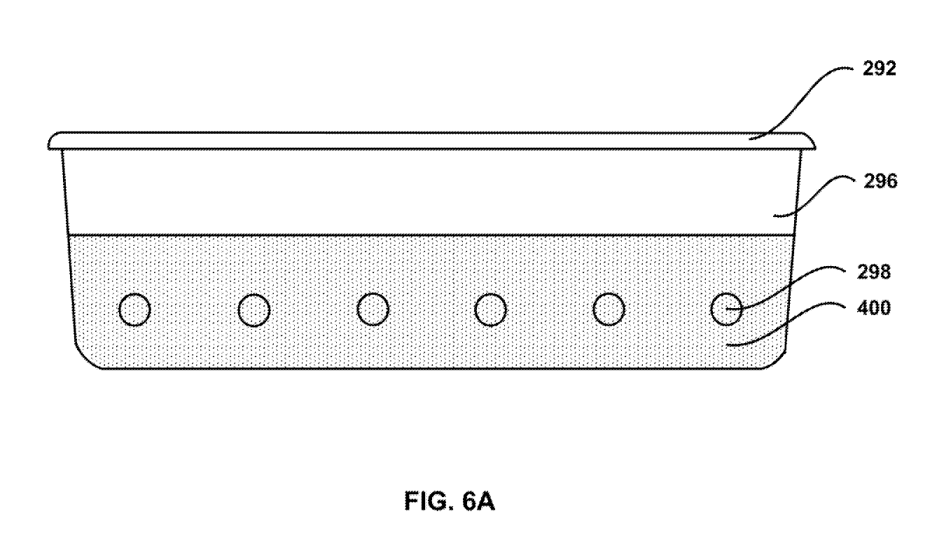

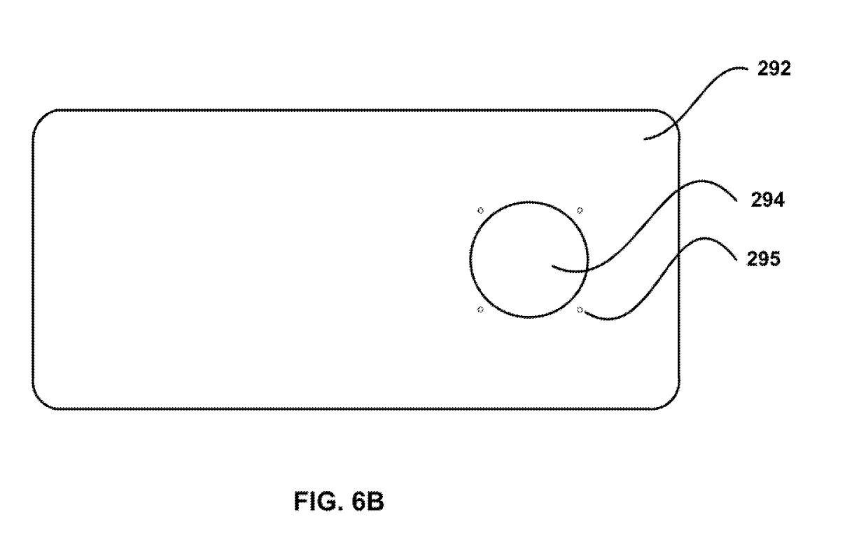

FIG. 6A schematically shows a side view of a filter box of a filtration system according to one embodiment of the invention. FIG. 6B schematically shows a top view of the filter box of FIG. 6A. Referring back to FIG. 1, the filter box 290 may be disposed beside the toilet bowl and located on the floor. As shown in FIGS. 6A and 6B, the filter box 290 includes a lid 292 and a main body 296. The lid 292 has a through hole 294. A plurality of holes 298 are formed on one side of the main body 296. The filter material 400 is accommodated in the filter box 290.

As shown in FIG. 6B, the lid 292 basically has a rectangular shape. The four corners of the lid 292 may be rounded. The circumference of the lid 292 may be curved downward to cover the main body 296 and to fix with the main body 296. In certain embodiments, the length of the lid 292 is in the range of 5-120 cm. In certain embodiments, the length of the lid 292 is in the range of 22-44 cm. In one embodiment, the length of the lid 292 is 33.02 cm (13 inch). In certain embodiments, the width of the lid 292 is in the range of 3-60 cm. In certain embodiments, the width of the lid 292 is in the range of 10-20 cm. In one embodiment, the width of the lid 292 is 15.24 cm (6 inch). The lid 292 of the filter box 290 has the through hole 294. The through hole 294 corresponds to the adaptor 250 and the fan 270. The adaptor 250 and the fan 270 are fixed to the filter box 290 at the location of the through hole 294. In certain embodiments, the adaptor 250 is located above the lid 292, the fan 270 is located below the lid 292. In one embodiment, each of the adaptor 250, the lid 292 and the fan 270 have corresponding fixing holes, and screws are used to hold the adaptor 250, the lid 292 and the fan 270 together via the corresponding fixing holes. For example, four fixing holes 295 are provided on the lid 292, and the location and size of the fixing holes 295 correspond to the location and size of the fixing holes 258 on the adaptor 250. In certain embodiments, the diameter of the through hole 294 is in a range of 1.5-20 cm. In certain embodiments, the diameter of the through hole 294 is in a range of 3.5-7 cm. In one embodiment, the diameter of the through hole 294 is about 5.1 cm (2 inch). The through hole 294 may be located at one end of the filter box 290. In certain embodiments, the center of the through hole 294 has equal distance to three adjacent sides of the lid 292. In one embodiment, the center of the through hole 294 has a distance of about 7.62 cm (3 inch) to each of the three adjacent sides of the lid 292.

As shown in FIG. 6A, the top of the main body 296 of the filter box 290 is covered by the lid 292. The top rectangular surface of the main body 296 is slightly smaller than the rectangular bottom of the lid 292. The bottom rectangular side of the main body 296 is smaller than the top rectangular surface of the main body 296. In certain embodiments, the length of the bottom rectangular side of the main body 296 is in the range of 4-120 cm. In certain embodiments, the length of the bottom rectangular side of the main body 296 is in the range of 22-44 cm. In one embodiment, the length of the bottom rectangular side of the main body 296 is about 30.48 cm (12 inch). The width of the bottom rectangular side of the main body 296 is smaller than the width of the top rectangular surface of the main body 296, and is smaller than the width of the lid 292. When the lid 292 is covered on the main body 296, the height of the filter box 290 is in a range of 2.5-40 cm. In certain embodiments, the height of the filter box 290 is in a range of 6-15 cm. In one embodiment, the height of the filter box 290 is about 10.16 cm (4 inch). The main body 296 of the filter box 290 has a plurality of holes 298. The holes 298 may be through holes. In certain embodiments, transparent screen is covered on the holes 298. The transparent screen not only prevent the filter material 400 from leaking, but also provide an observation window for a user to judge the status of the filter material 400 in the filter box 290. For example, the filter material 400 may change color after absorbing certain amount of odor component from the air, and when a substantial amount of the filter material 400 changes color, fresh filter material 400 is needed to replace the used filter material 400. In certain embodiments, the holes 298 forms a row, and the holes 298 are about 2.54 cm (1 inch) away from the bottom of the filter box. In certain embodiments, the distance between two adjacent holes 298 is about 5.08 cm (2 inch). In certain embodiments, the hole 298 at the end of the row is about 2.54 cm (1 inch) away from the side of the main body.

When the filter material 400 is put into the filter box 290, the height of the filter material 400 is higher than the holes 298. In certain embodiment, the filter material disposed in the filter box 290 is about 2.54 cm (1 inch) higher that the holes 298. In certain embodiments, the filter material 400 is disposed in the filter box 290 through opening the lid 292. In other embodiments, a door may be opened in one side of the filter box to dispose and remove the filter material 400, and under this situation, the lid may not be necessary.

In certain embodiments, at least one of the holes 298 is opened, such that the air from the bowl and running through the filter 400 may be released from the at least one of the holes 298. In other embodiments, optionally all the holes are sealed or covered holes, and another exit may be disposed on the filter box 290 for releasing air from the filter box 290. In order to make sure the odor does not fill the restroom, the exit should be lower than the filter material or at least partially blocked by the filter material, so that the air exits from the filter box 290 passes the filter material 400 first before being released out of the filter box 290.

In certain embodiments, the filter system may further include a check valve to prevent back flow of the air in the system.

In another aspect, the present invention relates to a filter system for eliminating odor in a restroom when the toilet is being used. In this type of design, the suction pipe is built into the seat hinge and the fan and the filter are built into the lid. Thus, no filter box is required on the floor.

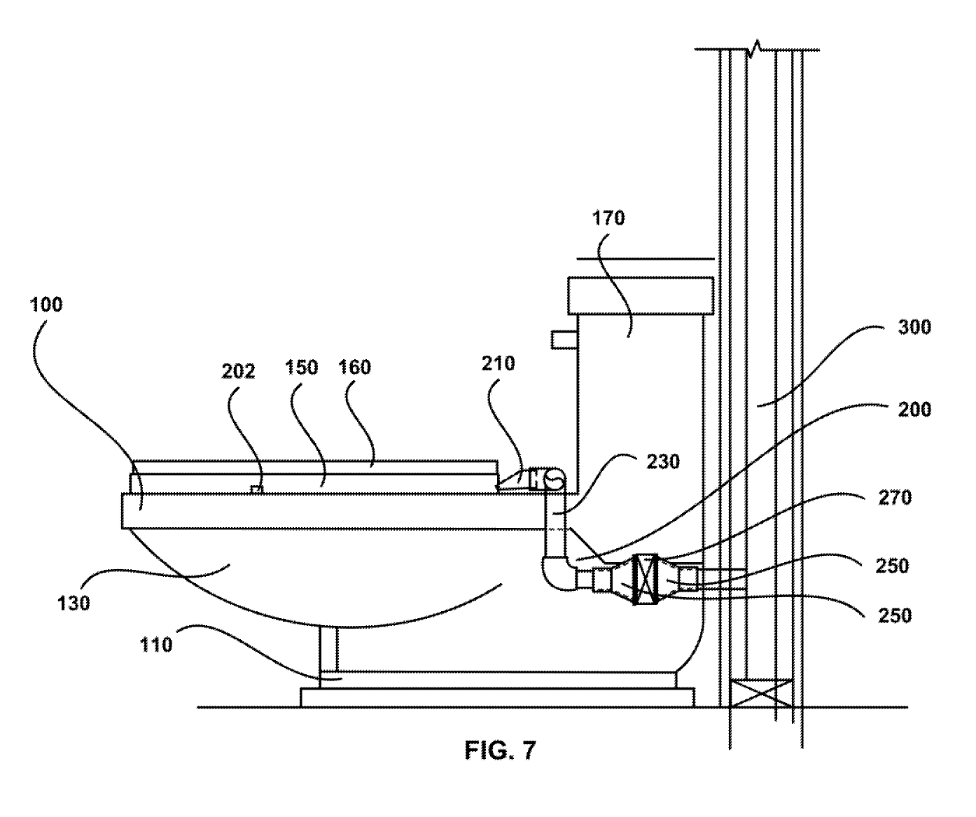

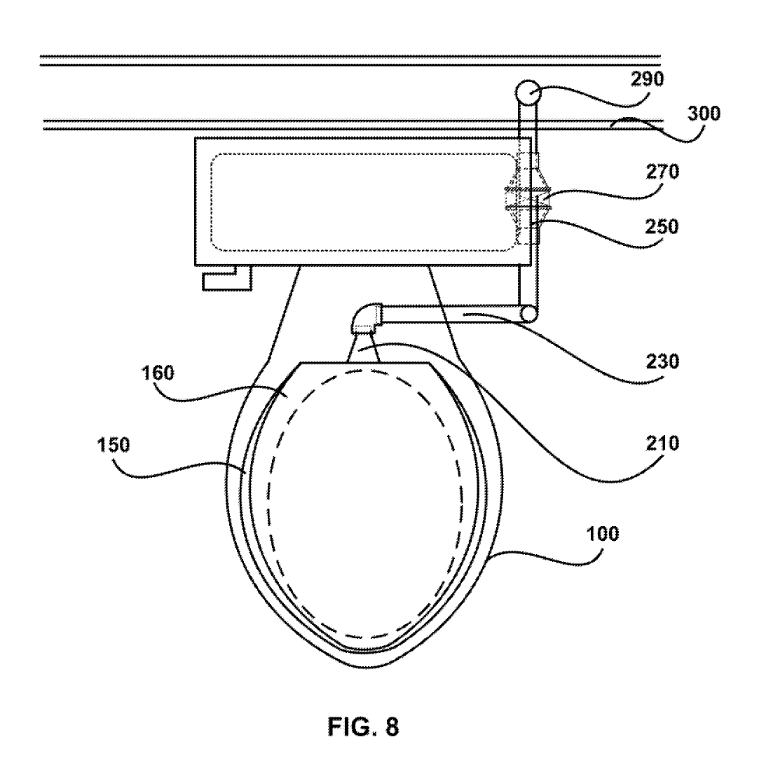

In a further aspect, the present invention relates to a filter system for eliminating odor in a restroom when the toilet is being used. FIG. 7 schematically shows a side view of a filtration system according to one embodiment of the invention. FIG. 8 schematically shows a top view of the filtration system of FIG. 7. The embodiment shown in FIGS. 7 and 8 is similar to the embodiment shown in FIGS. 1 and 2. The differences are: the filter box 290 is not required, and the fan 270 is sandwiched between two adaptors 250. The adaptor 250 away from the toilet bowl is further connected to venting pipe to venting the odor outside. In certain embodiments, the filter system may further includes a filter, for example disposed between one of the adaptors 250 and the fan 270.

In yet another aspect, the present invention relates to a filter system for eliminating odor in a restroom when the toilet is being used. In this type of design, the filter system as described above may be built into the toilet casting.

In another aspect, the present invention relates to a process of installing a filter system as described above to a current toilet, so as to remove odor efficiently during use. One of ordinary skill in the art would appreciate that, unless otherwise indicated, the length, width, angle, assembling sequence of the components of the filter system according to certain embodiments of the present invention are not limited to the implementations described above. Rather, this disclosure may be embodied in many different forms.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

Some references, which may include patents, patent applications, and various publications, may be cited and discussed in the description of this invention. The citation and/or discussion of such references, if any, is provided merely to clarify the description of the present invention and is not an admission that any such reference is “prior art” to the invention described herein. All references listed, cited and/or discussed in this specification are incorporated herein by reference in their entireties and to the same extent as if each reference was individually incorporated by reference.

What is claimed is:

1. A filtration system for eliminating odor, comprising:
a suction pipe opened with a first end and an opposite, second end;
a connecting pipe connected to the second end of the suction pipe;
an adapter connected to the connecting pipe;
a fan connected to the adapter; and
a filter box accommodating the fan and a filter material,
wherein the suction pipe is fixed to a top surface at a back side of a toilet bowl, the first end of the suction pipe faces the toilet bowl, and the adapter and the fan are fixed to the filter box; and
wherein at work, the fan generates a suction force such that air around the toilet bowl moves through the suction pipe, the connecting pipe, and the adapter into the filter box, and is processed by the filter material in the filter box.

2. The filtration system of claim 1, further comprising a pressure sensor disposed on the upper surface of the toilet bowl, wherein when a seat of the toilet is pulled down for use and thereafter occupied, the seat presses the pressure sensor, and the pressure sensor sends a signal to the fan to turn on the fan.

3. The filtration system of claim 1, wherein the second end of the suction pipe has a circular shape, the first end of the suction pipe has a flattened shape, an opening at the first end of the suction pipe is smaller than an opening at the second end of the suction pipe, so as to increase a suction force at the first end of the suction pipe.

4. The filtration system of claim 1, wherein the suction pipe includes a first pipe portion having the first end, and a second pipe portion having the second end, and the first pipe portion is bent from the second pipe portion.

5. The filtration system of claim 1, wherein
the connecting pipe has a first end connecting with the second end of the suction pipe, and a second end connecting with the adapter;
the adapter has a first end connecting with the second end of the connecting pipe, and a second end connecting with the fan; and
the adaptor further comprises a flange at the second end of the adaptor, so as to fix and seal the adaptor to the filter box.

6. The filtration system of claim 1, further comprising a check valve such that the air around the toilet bowl only moves in a direction from the suction pipe toward the connecting pipe.

7. The filtration system of claim 1, wherein the filter box is fixed to a floor.

8. The filtration system of claim 1, wherein the filter box further comprises at least one open hole, and at least part of the filter material is disposed between the fan and the open hole.

9. The filtration system of claim 8, wherein the open hole is covered by a transparent screen, and a height of the filter material is at least 1 inch greater than a top of the open hole.

10. The filtration system of claim 1, wherein the filter box further comprises a lid or a door, such that the filter material in the filter box is changeable through the lid or the door.

11. The filtration system of claim 1, wherein the suction pipe, the connecting pipe, and the adaptor are made of a polyvinyl chloride (PVC) material.

12. The filtration system of claim 1, wherein the filtration system is built into the toilet bowl.

13. A filtration system for eliminating odor, comprising:
a suction pipe opened with a first end and an opposite, second end;
a connecting pipe connected to the second end of the suction pipe;
a first adapter connected to the connecting pipe;
a fan connected to the first adapter; and
a second adapter, connected with the fan and a vent pipe,
wherein the suction pipe is fixed to a top surface at a back side of a toilet bowl, the first end of the suction pipe faces the toilet bowl; and
wherein at work, the fan generates a suction force such that air around the toilet bowl moves through the suction pipe, the connecting pipe, the first adapter, the fan, and the second adaptor into the vent pipe.

14. The filtration system of claim 13, further comprising a pressure sensor disposed on the upper surface of the toilet bowl, wherein when a seat of the toilet is pulled down for use and thereafter occupied, the seat presses the pressure sensor, and the pressure sensor sends a signal to the fan to turn on the fan.

15. The filtration system of claim 13, further comprising a check valve disposed in the vent pipe and adjacent to the second adaptor, to prevent backflow of the air toward the second adaptor.

16. The filtration system of claim 13, further comprising a filter between the fan and the second adaptor to remove odor from the air.

17. The filtration system of claim 13, wherein the second end of the suction pipe has a circular shape, the first end of the suction pipe has a flattened shape, an opening at the first end of the suction pipe is smaller than an opening at the second end of the suction pipe, so as to increase a suction force at the first end of the suction pipe.

18. The filtration system of claim 13, wherein the suction pipe includes a first pipe portion having the first end, and a second pipe portion having the second end, and the first pipe portion is bent from the second pipe portion.

19. A toilet having a filtration system for eliminating odor, the filtration system comprising:
a suction pipe having an opening in a bowl of the toilet;
a fan connected to the suction pipe; and
a connecting pipe having a first end connected with the fan, and a second connected with a drain,
wherein at work, the fan generates a suction force such that air around the toilet bowl moves through the suction pipe, the fan, and the connecting pipe to the drain.

20. The filtration system of claim 19, wherein the suction pipe, the fan, and part of the connecting pipe are integrally formed in the toilet, and the connecting pipe is connected to the drain after a P-trap of the drain.
